(19) United States
(12) Patent Application Publication
(10) Pub. No.: US 2024/0312443 A1
(43) Pub. Date: Sep. 19, 2024

(54) Scalable Pedalboard Mounting System

(71) Applicant: ROGER A. ROMERO, SAN LUIS OBSIPO, CA (US)

(72) Inventor: ROGER A. ROMERO, SAN LUIS OBSIPO, CA (US)

(21) Appl. No.: 18/186,166

(22) Filed: Mar. 18, 2023

(51) Int. Cl. G10H 1/34

(52) U.S. Cl. CPC G10H 1/348; G10H 2210/155; G10H 2220/265

(57) ABSTRACT

The present invention is a plurality of plates that can be configured in various ways to mount effects pedals together to case carrying them and keep the cabling intact. The present invention also includes a handle mounted directly on the pedal or plate to case carrying a single pedal or a plurality of pedals and plates.

### FIELD OF THE INVENTION

The present invention relates in general to pedalboards for a plurality of audio effects pedals, and more particularly, relates to connecting effects pedals together in a scalable system, with the capability to expand or reduce as the user adds or removes guitar effects pedals. Specifically, the invention relates to a novel technique for mounting effects pedals together with a plurality of mating plates that protrude outside of the effects pedal footprint. The invention also includes the use of a handle that is mounted on the effects pedal(s) to accommodate portability.

### BACKGROUND OF THE INVENTION

The present invention is in the technical field of musical instruments. More particularly, the present invention is in the technical field of electronic instruments that can use effects pedals. Effects pedals are electronic devices that modify or enhance the audio signal from the instrument or other devices. They are also referred to as stomp boxes. Effects pedals are typically placed on the floor, so that they can be turned on or off, hands-free, using a footswitch. Some typical electronic instruments include electric guitar/bass, microphone, keyboard/synthesizer, organ, lap steel, and violin.

The typical configuration is that the instrument plugs into a single of plurality of pedals using cables with ¼″ plug-style jacks. Additionally, the pedals typically connect to each other using cables with ¼″ plug-style jacks. Since there is a plurality of pedals that produce vastly different audio effects, it is typical for a musician to utilize more than one pedal. The output of the last pedal is then connected to an amplifier or mixing board using cables with ¼″ plug-style jacks.

It is common for musicians to carry their pedal(s) from one location to another, such as from home to a studio, practice location with teachers or other musicians, or to a stage for gigs. However, carrying a plurality of pedals is problematic in that they can get scratched carrying them separately in a bag and connecting them with cables each time is tedious. Because of these issues, there are pedalboards that mount a plurality of pedals together so that they can be transported easily with the cabling kept intact. The pedalboard is typically a physical device with a flat surface where a plurality of pedals can be mounted with a fastener such as screws, brackets, straps, or hook-and-loop. Some pedalboards also include built-in cable management systems for power connections and/or audio connections to the pedals to simplify the cabling. Musicians tend to frequently change the pedals they use on their pedalboard, whether they are adding more pedals, replacing a pedal with another, or reducing the number of pedals they use.

The shortcomings of many pedalboards are that they are a fixed size, or have some limited expansion capability, they are bulky, and they can be expensive. The fixed size means that the surface area of the pedalboard to mount pedals is either too small and can't fit all the pedals that are needed, or it is too big and there is wasted space making it bulky. This fixed size is further complicated as musicians change the configuration of their pedals frequently. Some pedalboards include expandability, where an expansion unit is bolted onto the main pedalboard to increase its surface area. However, the expansion unit is also a fixed size, so they too can be either too big or too small. A good example of a pedalboard with an expansion unit option is Stompblox. To solve these issues, D'Addario sells a telescopic pedalboard that expands or collapses to the custom size needed. It has one section that is a fixed size and then a second section that can slide in and out of the main section. But this pedalboard is still limited by the fixed size of its minimum configuration. Another shortcoming of all these pedalboards is that they are stand-alone units made of metal, heavy plastic, or wood and they tend to be heavy and bulky, especially if they include a cable management system. In addition, stand-alone pedalboards can be considered expensive, costing as much as an individual pedal or typically more.

### SUMMARY OF THE INVENTION

The present invention is a plurality of plates that mount to the effects pedals to create a connected set of pedals. In addition, a handle is mounted to the effects pedal(s) or plate(s) so that a user can grip the handle to carry the set of connected pedals. By aligning a plurality of respective plates, a user can scale the connectivity from two pedals to an infinite number of pedals.

There are three types of plates in the present invention; 1) the “head/tail” plate is mounted to the first pedal and a second one is mounted to the last pedal, 2) the “middle” plate is connected to each middle pedal(s), where there can be an unlimited number of “middle” pedals and the 3) the “extender” plate can be used for mounting odd-shaped pedals, for example with via hook-and-loop tape on the pedals and the plate. These plates leverage the rigid strength of the aluminum pedals themselves, so the plates can be made of light-weight material to minimize weight.

A handle is mounted to the first and/or the last pedal or it can be mounted to the “head/tail” plate so that the user can carry the assembly of pedals and plates similarly to carrying a typical pedalboard.

### BRIEF DESCRIPTION OF THE DRAWINGS

FIG. 1 is a top view of a “head/tail” plate of the present invention;

FIG. 2 is a perspective view of the “head/tail” plate of FIG. 1;

FIG. 3 is a perspective view of the “head/tail” plate of FIG. 1 with an effects pedal mounted below it (facing down);

FIG. 4 is a top view of the “head/tail” plate of FIG. 1 with an effects pedal mounted below it;

FIG. 5 is a top view of two “head/tail” plates of FIG. 1 aligned together to mount two pedals;

FIG. 6 is a perspective view of two “head/tail” plates of FIG. 1 aligned together to mount two effects pedals, with the pedals shown underneath;

FIG. 7 is a perspective view of two effects pedals mounted together with two “head/tail” plates of FIG. 1, with the plates shown underneath and the pedals facing up.

FIG. 8 is a second embodiment of the “head/tail” plate of FIG. 1, with flanges on the flat ends of the plate.

FIG. 9 is a perspective view of the second embodiment of the “head/tail” plate of FIG. 1 with flanges on the end.

FIG. 10 is a top view of two of the second embodiment of the “head/tail” plate of FIG. 1 with flanges on the end. They are aligned together to mount two pedals.

FIG. 11 is a perspective view of a handle that can be mounted on the effects pedal or one of the plates;

FIG. 12 is perspective view of the handle mounted on the effects pedal of the present invention, where two effects pedals are mounted together with two “head/tail” plates of FIG. 1;

FIG. 13 is a top view of the “middle” plate of the present invention;

FIG. 14 is a top view of the “middle” plate, with an effects pedal mounted below it;

FIG. 15 is a top view of two “head/tail” plates of FIG. 1 aligned with one “middle” plate of FIG. 13 mounted to three effects pedals shown underneath;

FIG. 16 is a perspective view of two “head/tail” plates of FIG. 1 aligned with one “middle” plate of FIG. 13;

FIG. 17 is a top view of two “head/tail” plates of FIG. 1 aligned with two “middle” plates of FIG. 13 mounted to four effects pedals shown underneath;

FIG. 18 is a perspective view of two “head/tail” plates of FIG. 1 aligned with two “middle” plates of FIG. 13

FIG. 19 is a top view of an “extender” plate of the present invention;

FIG. 20 is a top view of one “head/tail” plate of FIG. 1 aligned with one “extender” plate of FIG. 19 mounted to four effects pedals shown underneath. Two of the pedals are of odd size and can be mounted with hook-and-loop tape to the “extender” plate;

FIG. 21 is a perspective view one “head/tail” plate of FIG. 1, one “middle” plate of FIG. 10, and one “extender” plate of FIG. 19 aligned to fit together;

FIG. 22 is a top view of a third embodiment of the “head/tail” plate of the present invention with the handle from FIG. 11 mounted on the plate.

FIG. 23 is a side view of the third embodiment of the “head/tail” plate from FIG. 22 with the handle from FIG. 1 mounted on the plate.

FIG. 24 is a perspective view of the third embodiment of the “head/tail” plate from FIG. 22 with the handle from FIG. 11 mounted on the plate.

### DETAILED DESCRIPTION OF THE INVENTION

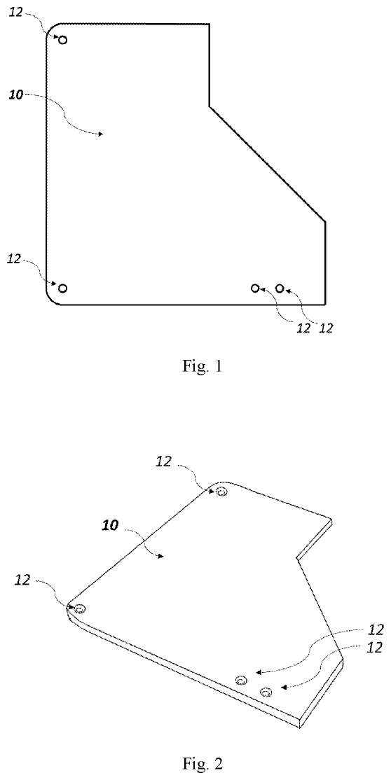

Referring now to the invention in more detail, in FIG. 1 and FIG. 2 there is shown a “head/tail” plate -10- according to the present invention. The “head/tail” plate -10- is a substantially rigid planar surface with a shape that spans a partial section of one pedal and a partial section of a second pedal in order to mount two pedals together. The plate can be made of a rigid material like high-strength plastic, metal, wood and the like. When a second “head/tail” plate -10- is rotated 180° degrees, it can align/mate with the first “head/tail” plate -10- in order to fully span the distance of two pedals. The plate -10- is comprised of a plurality of holes -12- for mounting screws -13- to the pedals.

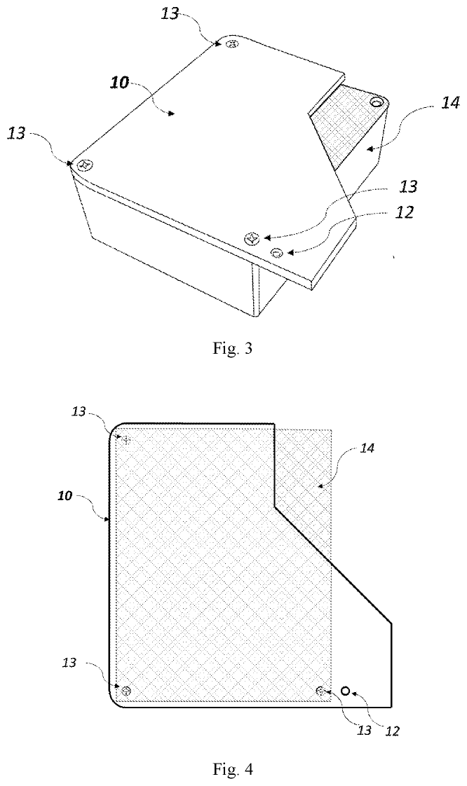

FIG. 3 and FIG. 4 shows the “head/tail” plate -10- mounted to an effects pedal -14- with its bottom facing up. The bottom of the pedal is shaded to contrast it from its top. Screws -13- are shown mounted through the holes -12- to fasten the plate -10- to the pedal -14-. The “head/tail” plate -10- is shown with one section protruding past the pedal.

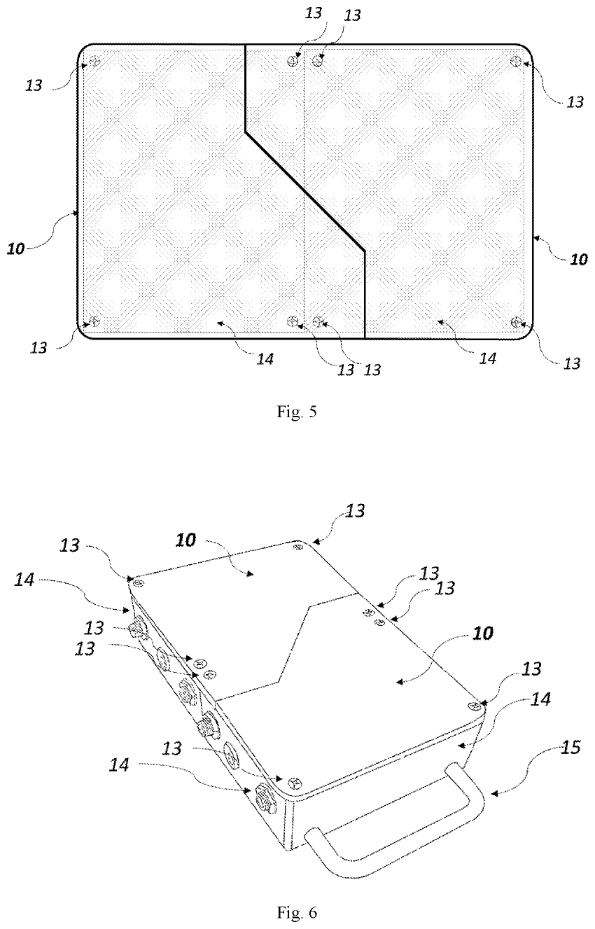

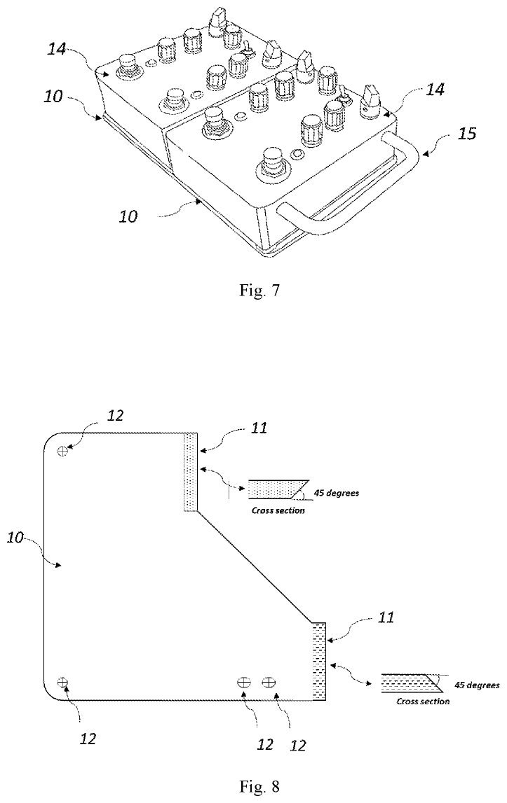

FIG. 5 through FIG. 7 shows two “( -10-, -16-, -17-) mounted to two effects pedals -14-. A second “head/tail” plate -10- is rotated 180° degrees, to align/mate with the first “head/tail” plate -10- in order to fully span the bottom surface area of two pedals. Screws -13- are shown mounted through the holes -12- to fasten the plates -10- to the pedals -14-. FIG. 6 shows the plates -10- on top and the pedals -14- facing downwards. FIG. 7 shows the pedals -14- facing upwards and the plates -10- on the bottom, which is the intended use of this invention.

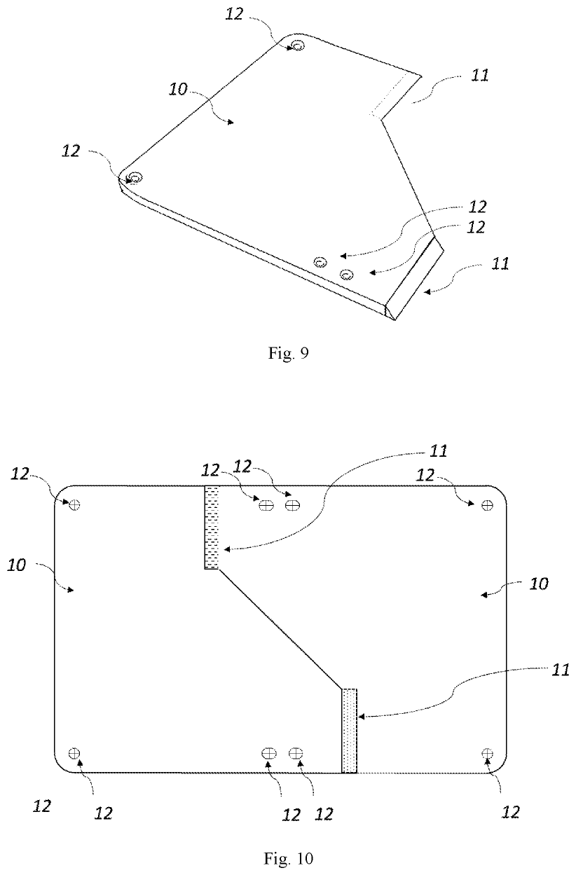

In FIG. 8 through FIG. 10 there is a shown a second embodiment of the “head/tail” plate -10- in FIG. 1. The flat ends of the plate that mate with a second “head/tail” plate -10- are tapered with a 45-degree angle as shown in FIG. 8 with a cross section view. When two “head/tail” plates -10- are mounted together, the 45-degree ends prohibit the bending of the two plates, creating a very rigid assembly.

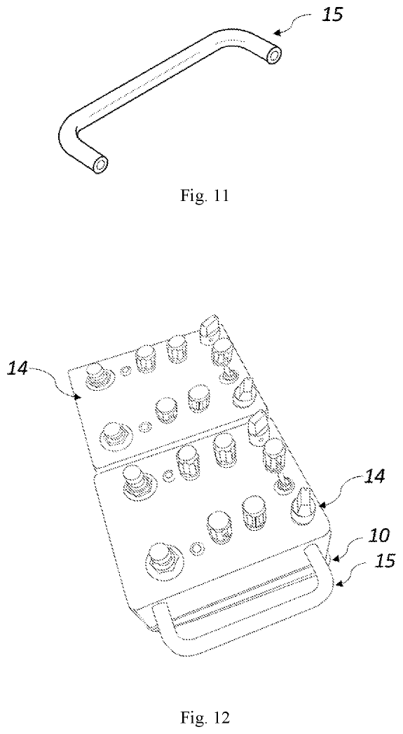

In FIGS. 11 and 12 there is shown a handle -15- mounted on the pedal according to the present invention. The handle -15- is made of a substantially rigid material and is curved on both ends and mounted to one pedal -14-. It is wide enough to allow a human hand to grab the handle -15- in order to easily carry that pedal. One embodiment of the invention is an assembly of one handle -15- mounted to one pedal -14- without any plate ( -10-, -16-, -17-). A second embodiment is one handle -15- mounted to one pedal -14- and mounted with one or a plurality of plates ( -10-, -16-, -17-) and pedals. A third embodiment is the first and last pedals -14- each mounted with a handle -15- mounted to a plurality of plates ( -10-, -16-, -17-).

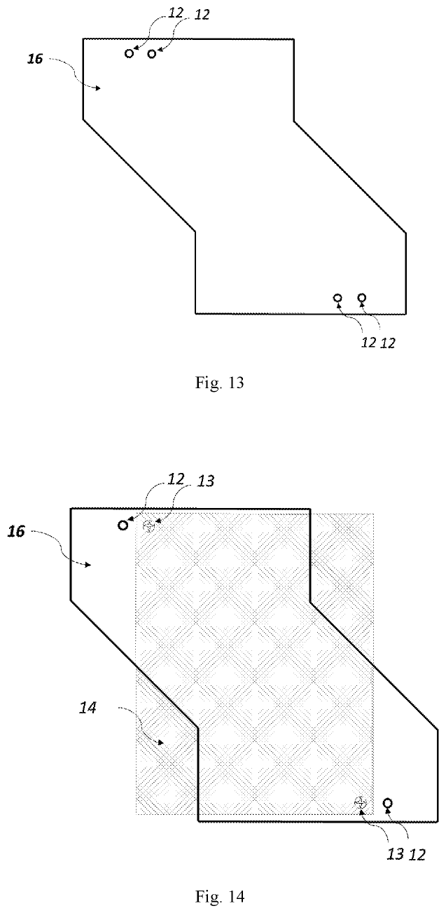

In FIG. 13 there is shown a “middle” plate -16- according to the present invention. The “middle” plate -16- is a substantially rigid planar surface with a shape that spans a partial section of three pedals in order to mount three pedals together.

FIG. 14 shows the “middle” plate -16- mounted to an effects pedal -14- with its bottom facing up. The bottom of the pedal is shaded to contrast it from its top. Screws -13- are shown mounted through the holes -12- to fasten the plate -10- to the pedal -14-. The “middle” plate -16- is shown with one section protruding past the pedal on the left and one section protruding past the pedal on the right.

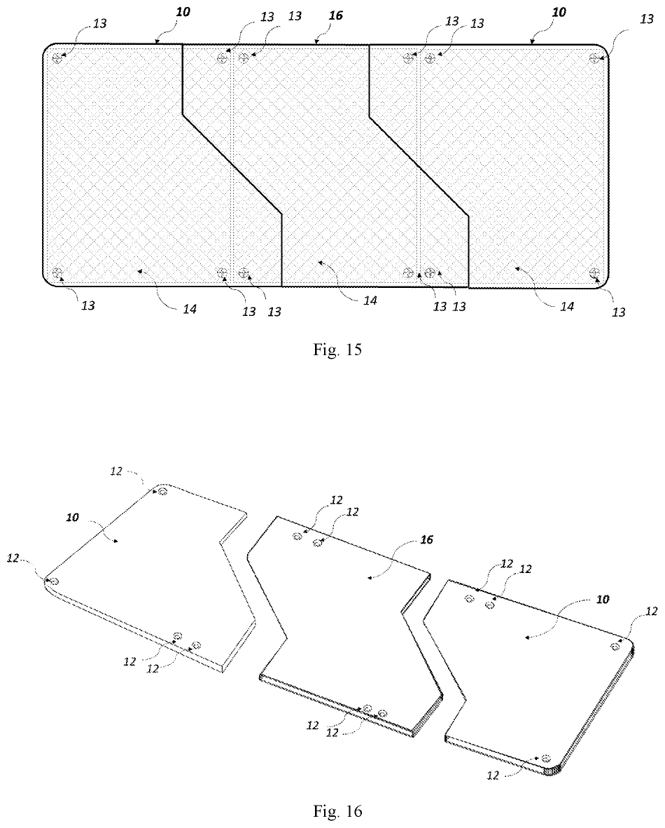

FIG. 15 and FIG. 16 shows the “middle” plate -16- and two “head/tail” plates -10- configured together in order to mount to three effects pedals -14-. The second “head/tail” plate -10- is rotated 180° degrees, to align/mate with the “middle” plate -16- in order to fully span the bottom surface area of three pedals. Screws -13- are shown mounted through the holes -12- to fasten the plates -10- to the pedals -14-.

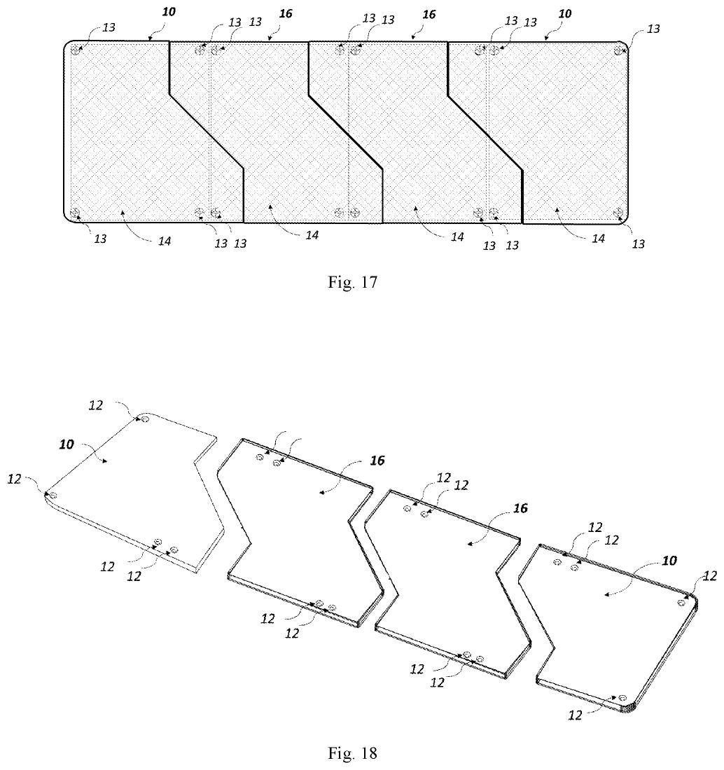

FIG. 17 and FIG. 18 shows two “middle” plates -16- and two “head/tail” plates -10- configured together in order to mount four effects pedals -14-. The second “head/tail” plate -10- is rotated 180° degrees, to align/mate with the second “middle” plate -16- in order to fully span the bottom surface area of four pedals. Screws -13- are shown mounted through the holes -12- to fasten the plates -10- to the pedals -14-. By adding additional “middle” plates -16-, the system continues to scale to mount additional plurality of pedals.

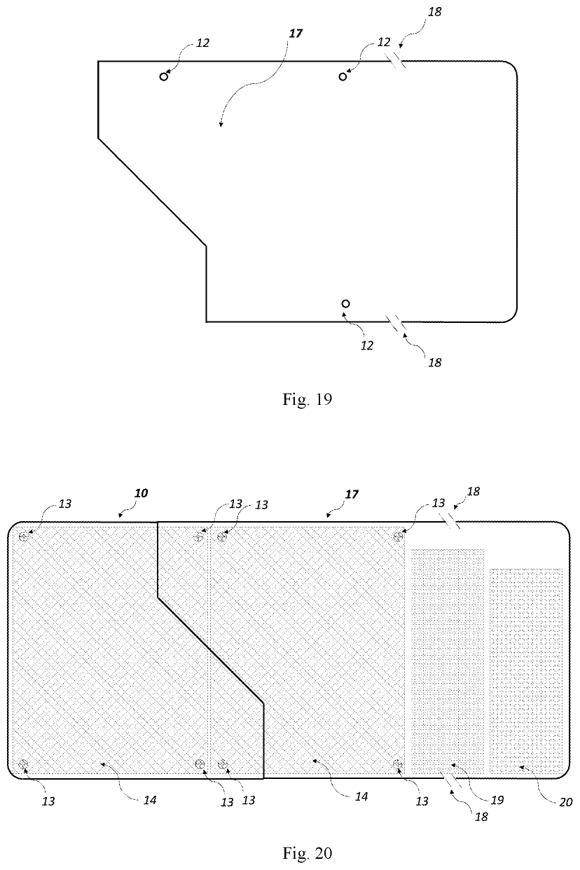

In FIG. 19 and FIG. 20 there is shown an “extender” plate -17- according to the present invention. The “extender” plate -17- is a substantially rigid planar surface with a shape that spans a partial section of two pedals in order to mount two pedals -14- together. The “extender” plate -17- also includes a flat space that allows the mounting of additional alternatively sized pedals, with two examples shown -19- and -20-. These pedals can be mounted with hook-and-loop. A second embodiment of the “extender” plate -17- is to lengthen or shorten the size of the flat surface -18- in order to fit a plurality of pedals. A third embodiment of the “extender” plate is to include mounting holes to match the screw holes of alternative sized pedals.

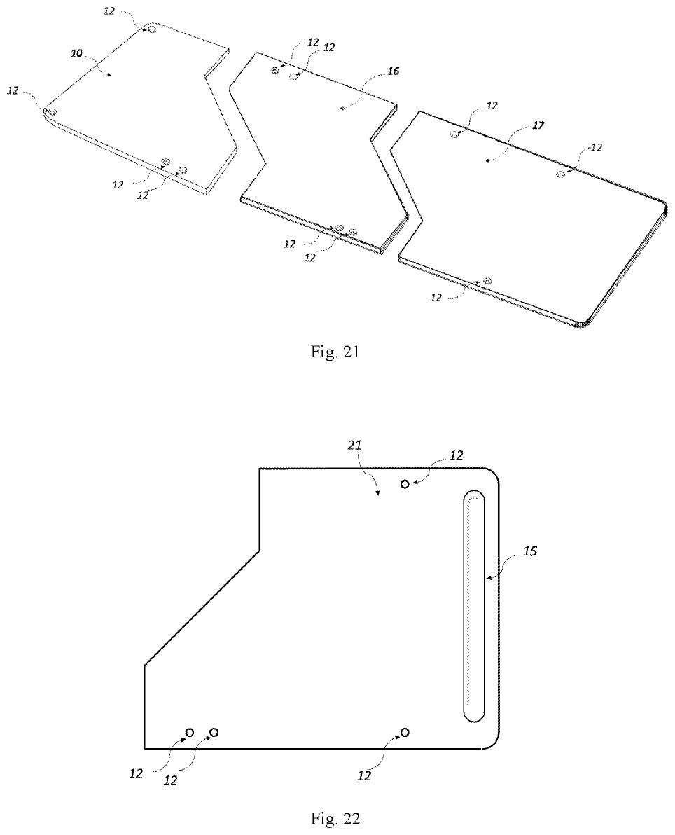

FIG. 21 shows the “extender” plate -17- configured with one “head/tail” plate -10-, and one “middle” plate -16-. This configuration supports three standard size pedals -14- and a plurality of alternative sized pedals.

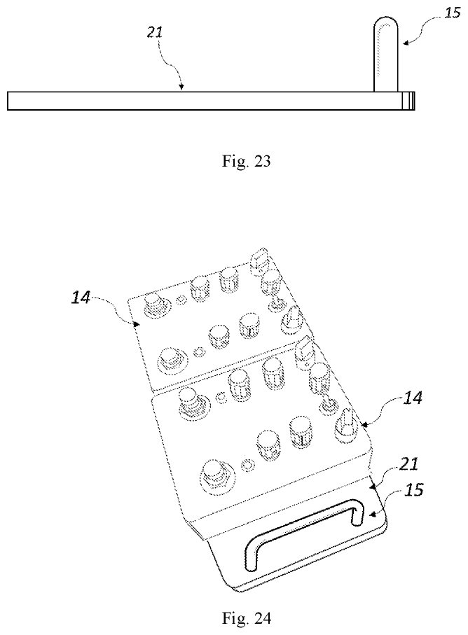

In FIG. 22 through FIG. 24 there is shown a third embodiment of the “head/tail” plate -21- with the handle -15- mounted on the plate according to the present invention. The third embodiment of the “head/tail” plate -21- expands the planar surface so that the handle -15- is mounted on the plate with room for a human hand to grip the handle -15- and not be impeded by the pedal -14-.

The advantages of the present invention include, without limitation, a) a low cost alternative to existing pedalboards; a consumer buys one plate for each pedal added to the system, which is a fraction of the cost of a pedalboard, b) it easily scales up or down depending on the number of pedals joined together, making it easy to stow in a backpack or carrying case, c) the weight of the plates is a fraction of a standard pedalboard, also making it easy to carry, and d) a handle mounted on the pedal makes it easy to carry.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

### ABSTRACT

The present invention is a plurality of plates that can be configured in a plurality of ways to mount effects pedals together to ease carrying them and to keep the cabling intact. The present invention also includes a handle mounted directly on the pedal or plate to also ease carrying a single pedal or a plurality of pedals and plates mounted together.

1. A method for joining two or more effects pedals together, comprising of:
(a) providing said two or more effects pedals and positioning them side-by-side so their bottoms can be mounted together with two or more mounting plates that mate together utilizing a mounting method such as screws or hook and loop. Unlike an existing effects pedalboard which is a singular physically fixed-size board to mount multiple pedals to it, the use of two more mounting plates allows the system to scale as more pedals are mounted to the system.
(b) at later points of time, more effects can be mounted together by using one or more of the mounting plates
whereby said two or more effects will be mounted together at the bottom using multiple mounting plates to make them easy to carry together. A hand-held device mounted directly on one or more effects pedals for the purposes of carrying one or more pedals:
(a) Singular Pedal use: a handle screwed directly to an effects pedal allows for carrying said pedal
(b) Multiple Pedal use: a handle screwed directly to one or more effects pedals in conjunction with the mounting plates detailed above provide a holistic solution for carrying two or more pedals together.
